(19) United States
(12) Patent Application Publication
(10) Pub. No.: US 2024/0066728 A1
(43) Pub. Date: Feb. 29, 2024

(54) COMBINATION UTILITY KNIFE, STUD FINDER, JAB SAW AND LEVEL

(71) Applicant: Bryant Thomas Kearney, Florence, OR (US)

(72) Inventor: Bryant Thomas Kearney, Florence, OR (US)

(21) Appl. No.: 17/823,646

(22) Filed: Aug. 31, 2022

(51) Int. Cl. B26B 11/00; B23D 51/10; G01V 3/08

(52) U.S. Cl. CPC B26B 11/001; B23D 51/10; G01V 3/08

(57) ABSTRACT

A sheetrock cutting tool incorporating a utility knife blade, a jab saw blade, a vertical and horizontal levels, and a stud-finder functionality is provided. The two blades are along opposing ends of the handle of the sheetrock cutting tool and the blades fold in and out of open and closed positions in opposing directions. The handle embeds both vertical and horizontal levels for facilitating level, straight and accurate perpendicular cuts with the two blades. Housed inside the handle are magnetizable material that enable the stud-finder functionality.

### BACKGROUND OF THE INVENTION

The present invention relates to multi-tools and, more particularly, a combination utility knife, stud finder, jab saw, and level.

Making accurate cuts in sheetrock (for an electrical box, for example) requires the use of four commonly used tools: a stud finder, a jab saw, a utility (or razor) knife, and a level. These four commonly used tools have been refined to near perfection, but there is no device that incorporates them all into a single, compact device. Which is unfortunate because switching between these tools mid-task is cumbersome and can even be dangerous when in a compromising physical position, such as being up on a ladder or navigating a cramped attic or crawlspace. And individual tools are easily lost or dropped in tight spaces, requiring extra time to find and switch tools in cramped or dark spaces.

There are “multi-tool” devices offering a variety of tool combinations, most of which are unrelated to the completion of a single, common task. As a result, such “multi-tool” options on the market incorporate tools that are often never used due to their lack of utility; these multi-tools have too many tool portions, many of which people rarely use, thereby these neglected tools portions get in the way of use of the other tool, add needless weight to the tool, and tend to waste needless time searching for the few tools one uses repeatedly in the single, common task of cutting sheetrock.

As can be seen, there is a need for a combination utility knife, stud finder, jab saw, and leveling tool that is embodied in a method of making accurate cuts to sheetrock.

### SUMMARY OF THE INVENTION

The present invention may include a combination of the following four tools critical for cutting sheetrock: a utility knife, a stud finder, a jab saw, and horizontal and vertical levels. The present invention allows these four tools to be incorporated together in a single, compact, convenient unit that can be carried in a pocket or belt, allowing for greater ease of movement, and enabling efficient switching between tools in difficult spaces or positions because of the absence of superfluous tools. During the process of cutting sheetrock, the compact hand tool embodied in the present invention allows the user to identify a wood or metal stud and make a complete, straight, or angular cut in the sheetrock with a single tool rather than four individual ones. The present invention embodies a singular tool combining four of the most used tools in the building industry, without sacrificing the size or utility of any of them. This tool could quickly become the preferred tool of electricians, plumbers, contractors, and DIY homeowners.

In one aspect of the present invention, a combination tool includes the following: a handle with a housing chamber; a knife blade rotatably received in the housing chamber so as to move between a first closed position and a first open position pivoted in a first direction; a jab saw blade rotatably received in the housing chamber so as to move between a second closed position and a second open position pivoted in a second direction opposite the first direction; and the handle having a flat spine; a horizontal sight level embedded in the flat spine; and a vertical sight level adjacent to the flat spine, wherein the horizontal sight levels are oriented orthogonally relative to each other.

In another aspect of the present invention, the combination tool further includes wherein the horizontal sight level is oriented to be read in a direction parallel to the knife blade, wherein the vertical sight level is disposed adjacent knife blade, wherein a recess portion is defined by a cutout in a portion of the flat spine and an adjacent sidewall of the handle; and further includes one or more magnetizable objects housed inside the housing chamber, wherein the one or more magnetizable objects are configured to be used as a stud finder, wherein the jab saw blade is configured to pierce and cut sheetrock by way of a sharp tip and a plurality of serrated teeth, respectively, and wherein the jab saw blade and the knife blade are movable between a locked condition and an unlocked condition in the respective open positions.

In yet another aspect of the present invention, a method of efficiently cutting a sheetrock includes the following: providing the above-mentioned combination; locating a hidden stud hidden behind the sheetrock by way of sliding the flat spine along a surface of the sheetrock and feeling for a magnetic resistance associated with the hidden stud; pivoting the jab saw blade to the second open position; moving the jab say blade to the locked condition; piercing the sheetrock with the sharp tip; using the horizontal level and the vertical level to guide a plurality of first cuts, respectively, in the sheetrock; moving the jab saw blade to the unlocked condition and the second closed position; pivoting knife blade to the first open position; moving the knife blade to the locked condition; and using the horizontal level or the vertical level to guide another horizontal or vertical second cut associated with the plurality of first cuts.

In yet still another aspect of the present invention, a sheetrock cutting tool consists of the following: a handle with a housing chamber; a knife blade rotatably received in the housing chamber so as to move between a first closed position and a first open position pivoted in a first direction; a jab saw blade rotatably received in the housing chamber so as to move between a second closed position and a second open position pivoted in a second direction opposite the first direction; a horizontal sight level and a vertical sight level, each connected to the handle; and magnetizable material housed in the housing chamber.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention, shown in a closed mode.

FIG. 2 is a bottom perspective view of an exemplary embodiment of the present invention, shown in the closed mode.

FIG. 3 is a side elevation view of an exemplary embodiment of the present invention, shown in the closed mode.

FIG. 4 is a detailed perspective view of an exemplary embodiment of the present invention, shown in a cross-section taken along line 4-4 in FIG. 3.

FIG. 5 is a top perspective view of an exemplary embodiment of the present invention, shown in an open mode.

FIG. 6 is a bottom perspective view of an exemplary embodiment of the present invention, shown in the open mode.

FIG. 7 is an exploded top perspective view of an exemplary embodiment of the present invention, shown in the open mode.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a sheetrock cutting tool providing a utility knife blade, a jab saw blade, a vertical and horizontal levels, and a stud-finder functionality is provided. The two blades are along opposing ends of the handle of the sheetrock cutting tool and the blades fold in and out of open and closed positions in opposing directions. The handle embeds both vertical and horizontal levels for facilitating level, straight and accurate perpendicular cuts with the two blades. Housed inside the handle are magnetizable material that enable the stud-finder functionality.

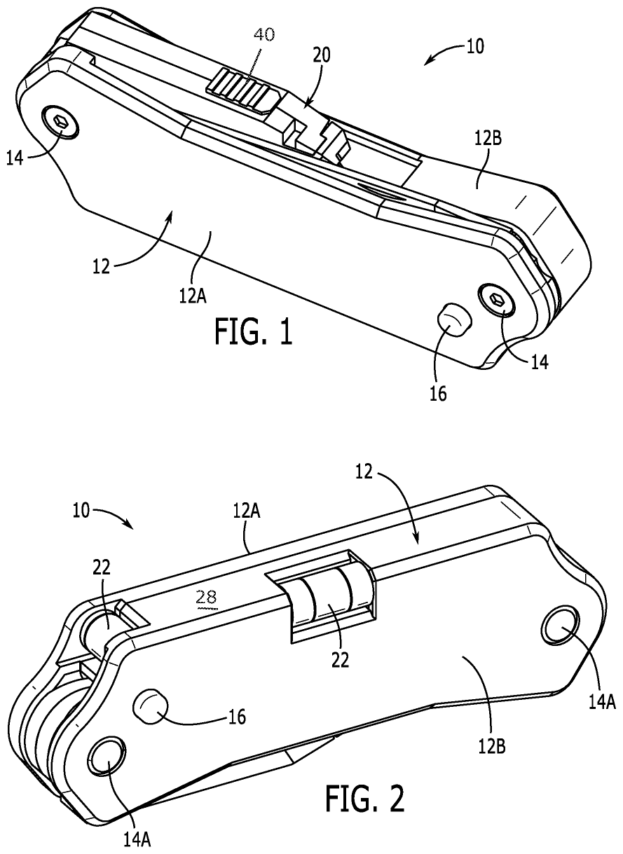

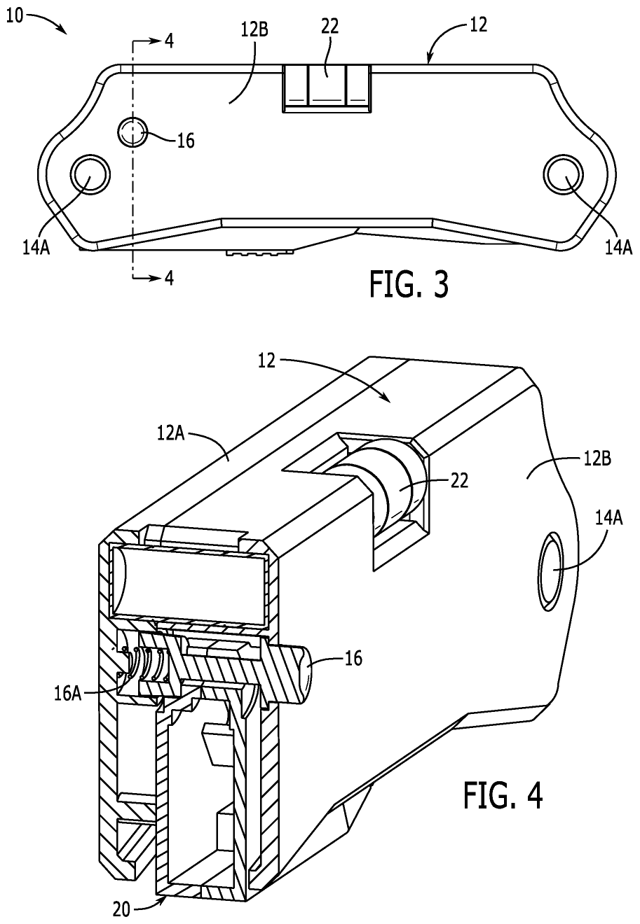

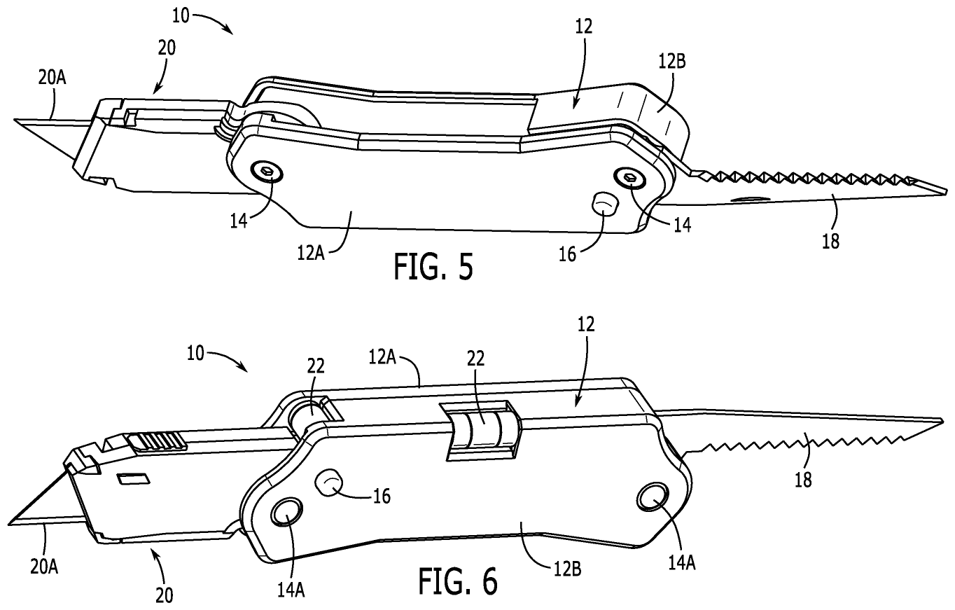

Referring now to FIGS. 1 through 7 the present invention may include a sheetrock cutting tool 10. The sheetrock cutting tool 10 has a handle 12 comprised of two sidewalls 12A, 12B, which are fixedly connected and spaced from each other by a pivot pin 14A on both sides of the sidewalls, thereby forming a housing chamber 30 therebetween. Spacers 32 may be disposed substantially perpendicular to the sidewalls 12A, 12B and arranged in the housing chamber 30.

A knife unit 20 is arranged at the first end of the handle 12 and can rotate about the pivot pin 14A in a first pivoting direction between an open position and a close position, so that when the knife unit 20 reaches the close position, it can be received in the housing chamber 30. The pivot pin 14A may be secured by the way of a fastener 14, such as a screw, through an opposing sidewall 12A. The knife unit 20 is composed of a utility handle 21 and a locking and release mechanism 40 to release, remove and replace disposable razor blades 20A. The razor blades 20A may be used to make clean, detailed cuts in sheetrock and other soft materials.

A jab saw blade 18 is arranged at the second end of the handle 12 and can rotate in a second pivoting direction between the open position and close position. When the jab saw blade 18 reaches its close position, it can be received in the housing chamber 30 between the sidewalls 14A. The folding jab saw blade 18 is dimensioned and adapted to make initial sheetrock cuts; the jab saw blade 18 is composed of a sharp steel point and small serrated teeth.

The pivoting and folding of the tools 20 and 18 may be enabled by a torsion spring 16B and/or a wave disc spring 26 that operatively associate with the pivot pin 14A and the distal end of the tool 20 and 18. The distal end may have an aperture 19 that receives the torsion spring 16B, and the pivot pin 14A may be slidably received in the wave disc spring 26 and the torsion spring 16B.

When the knife unit 20 or the jaw saw blade 18 are unfolded to the open position, the tail of each tool may be restricted by a locking mechanism 17, so that the tool is prevented from rotating to the closed position. Either the tail may have a notch or opening through which the locking mechanism slidably engages and disengages moving the tool between a locked condition and an unlocked condition. The locking mechanism 17 may be released through engaging a push button 16 that protrudes through an opening 12C in one of the sidewalls 12B. The push button 16 may enable and disable the locking mechanism 17 with the assistance of an operatively associated compression spring 16A.

The spacers 32 inside the housing chamber 30 may define end walls of magnet compartments 25 therein for storing the magnetizable material 24 configured (e.g., with respect to their polarity) to identify metal objects such as nails or metal wall studs. These incorporated magnetizable materials 24 enable a magnetic stud finder functionality. The magnet compartments 25 are disposed along a flat spine 28 of the handle 12.

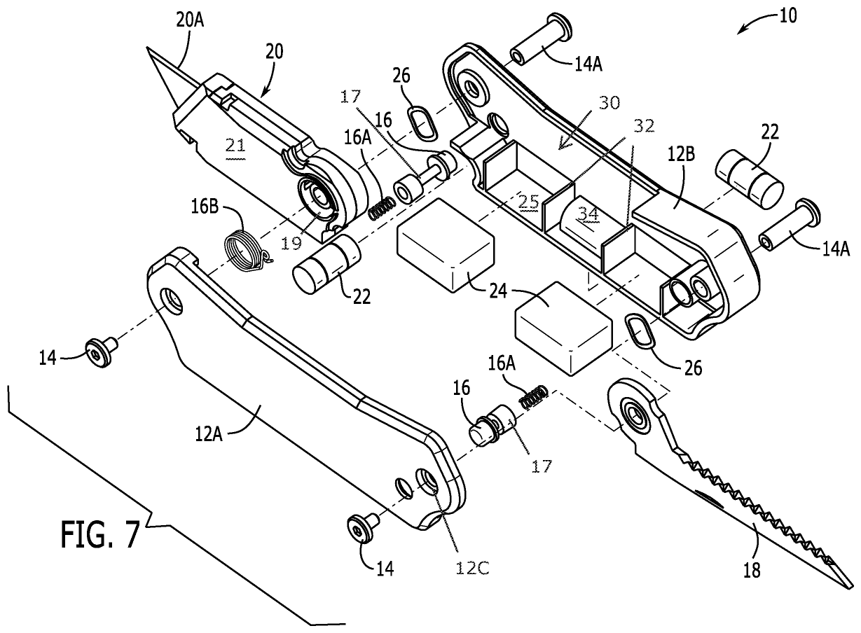

Horizontal and vertical sight levels 22 are embedded in the sheetrock cutting tool 10/handle 12. The horizontal level 22 may be disposed along the spine 28 of the handle 12. In some embodiments, a portion of the spine 28, a portion of the sidewall 12B, and an associated interconnecting edge may provide a recess portion 34 so that the sight level 22 may be connected therein. The sight level 22 is disposed substantially to exactly parallel to the cutting edge of the blade 20A and the jab saw blade 18, as illustrated in FIGS. 6 and 7, thereby facilitating straight/level horizontal cuts therewith. Therefore, the horizontal sight level 22 is substantially colinear with these tool cutting blades. The vertical level 22 may be disposed at an end of the spine 28 or adjacent thereto. The vertical level 22 is oriented perpendicular to the horizontal level 22. The vertical level 22 may be disposed adjacent the knife unit 20 and oriented perpendicular to the cutting edge of its blade 20A to facilitate straight/level vertical cuts that are perpendicular to the horizontal cuts.

The sheetrock cutting tool 10 is designed and configured to making accurate cuts in existing sheetrock substrate for light switches, outlet boxes, etc. A method of using the present invention may include the following. First, a user would locate the wood or metal stud hidden behind the sheetrock by placing the flat back/spine 28 along the surface of the sheetrock (not shown), slowly moving the tool horizontally and vertically over the surface until one feels the magnetic resistance associated with the stud-related metal below the surface. Then a user would unfold the jab saw blade 18 until it locks into place and, holding the handle 12, pierce the sheetrock with the metal tip of the saw 18. Using the embedded level 22 as a guide, slowly make horizontal and/or vertical cuts in the sheetrock to the desired shape. If the desired shape is a square, for instance, the user would cut out three of the four sides using the jab saw blade 18 with the levels 22 as a guide. Then the user unlocks the jab saw blade 18 and fold it back into the handle 12 into the closed position. Finally, the user unfolds the knife until 12 so that it locks into place and, using the level 22 as a guide, makes the final cut(s) and removes the sheetrock square. The user then unlocks the utility knife unit 12 and fold it back into the sheetrock cutting tool 10.

Additionally, the present invention can be used in nearly every field of residential and commercial contracting: e.g., electricians running and stripping wire to plumbers cutting a utility door behind a shower.

A method of manufacturing the present invention may include a battery-operated level and/or laser pointer, that could be added to improve accuracy. The handle 12 of the tool could also be made of a magnetized material, eliminating the need for individual magnetizable material 24 embedded in the handle 12. The components can be reconfigured in a variety of ways: in certain embodiments, the utility knife unit 10 and jab saw blade 12 could trade positions, the stud-finding magnetizable material 24 could be relocated to the side, and the embedded levels 22 could be disposed along other parts of the handle 12.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A combination tool comprising:
a handle with a housing chamber;
a knife blade rotatably received in the housing chamber so as to move between a first closed position and a first open position pivoted in a first direction;
a jab saw blade rotatably received in the housing chamber so as to move between a second closed position and a second open position pivoted in a second direction opposite the first direction; and
the handle having a flat spine;
a horizontal sight level embedded in the flat spine; and
a vertical sight level adjacent to the flat spine, wherein the horizontal sight levels are oriented orthogonally relative to each other.

2. The combination tool of claim 1, wherein the horizontal sight level is oriented to be read in a direction parallel to the knife blade.

3. The combination tool of claim 2, wherein the vertical sight level is disposed adjacent knife blade.

4. The combination tool of claim 3, wherein a recess portion is defined by a cutout in a portion of the flat spine and an adjacent sidewall of the handle.

5. The combination tool of claim 4, further comprising one or more magnetizable objects housed inside the housing chamber.

6. The combination tool of claim 5, wherein the one or more magnetizable objects are configured to be used as a stud finder.

7. The combination tool of claim 6, wherein the jab saw blade is configured to pierce and cut sheetrock by way of a sharp tip and a plurality of serrated teeth, respectively.

8. The combination tool of claim 7, wherein the jab saw blade and the knife blade are movable between a locked condition and an unlocked condition in the respective open positions.

9. A method of efficiently cutting a sheetrock, the method comprising:
providing the combination tool of claim 8;
locating a hidden stud hidden behind the sheetrock by way of sliding the flat spine along a surface of the sheetrock and feeling for a magnetic resistance associated with the hidden stud;
pivoting the jab saw blade to the second open position;
moving the jab say blade to the locked condition;
piercing the sheetrock with the sharp tip;
using the horizontal level and the vertical level to guide a plurality of first cuts, respectively, in the sheetrock;
moving the jab saw blade to the unlocked condition and the second closed position;
pivoting knife blade to the first open position;
moving the knife blade to the locked condition; and
using the horizontal level or the vertical level to guide another horizontal or vertical second cut associated with the plurality of first cuts.

10. A sheetrock cutting tool, consisting of:
a handle with a housing chamber;
a knife blade rotatably received in the housing chamber so as to move between a first closed position and a first open position pivoted in a first direction;
a jab saw blade rotatably received in the housing chamber so as to move between a second closed position and a second open position pivoted in a second direction opposite the first direction;
a horizontal sight level and a vertical sight level, each connected to the handle; and
magnetizable material housed in the housing chamber.
